(19) United States
(12) Patent Application Publication
(10) Pub. No.: US 2015/0210248 A1
(43) Pub. Date: Jul. 30, 2015

(54) KEYLESS ANTI-THEFT DEVICE

(71) Applicant: Aleksandr Konstantinovich Sidorov, Moscow (RU)

(72) Inventor: Aleksandr Konstantinovich Sidorov, Moscow (RU)

(21) Appl. No.: 14/375,040

(22) PCT Filed: Aug. 22, 2012
(86) PCT No.: PCT/RU2012/000691

§ 371 Date: Oct. 14, 2014

(30) Foreign Application Priority Data
Jul. 30, 2012 (RU) RU2012132530
Aug. 22, 2012 (RU) PCTRU2012000691

(51) Int. Cl. B60R 25/06; B60R 25/23; F16H 61/22

(52) U.S. Cl. CPC B60R 25/066; F16H 61/22; B60R 25/23; F16H 2059/0282

(57) ABSTRACT

The technical solution relates to anti-theft devices for locking the transmission of goods and passenger vehicles. The device comprises a security part in the form of a set of code and false keys with rods which are connected by means of three-dimensional levers to weights of a drive mechanism of a locking means, which is in the form of a rocker arm with a limiter for limiting the travel of a gearbox lever. The weights are arranged in baskets which are rigidly connected to the rocker arm. The torque relative to the axis of the rocker arm from the action of the total weight of counterweights and a ballast part of said rocker arm exceeds the counteracting torque from the action of the weight of the locking part thereof. In the locking position of the gearbox lever, the rods of the code keys rest in the base of the basket of the ballast part of the rocker arm. All of the tightening weights of the false keys also have a movement value. The distance from the base of the baskets of the false keys in the locking part of the rocker arm is greater than the distance from the axis of the rocker arm to the weights on contact between the two. Each of the rods is equipped with a rotation limiter, axial movement limiters and an upper position stop. The security part is equipped with means for balancing the total weight of the moveable elements of said security part. The counterweights and the tightening weights are formed from magnetically resistant materials. An increase in the security and a simplification of the design are achieved.

### BACKGROUND OF THE INVENTION

1. Field of the Invention

The invention relates to the transport industry, in particular to the anti-theft devices for locking the transmission of the vehicle and may be used for installation on trucks and cars.

2. Description of the Related Art

The following device of the same purpose is known from data generally available up to the priority date of the declared technical solution: a keyless anti-theft device, comprising a security part, a locking means of the gearbox lever and a drive mechanism of a locking means, wherein the security part is made in the form of a set of code and false keys with rods mounted by means of sealing in the gearbox and which are connected by means of three-dimensional levers with the weights of a drive mechanism of the locking means, which is in the form of a rocker arm; said rocker arm set to allow its vertical rotation with respect to axis. A locking end of the rocker arm having a limiter for limiting the travel of a gearbox lever adapted for interacting with stopper, which is rigidly connected to the gearbox lever. The device is equipped with a downstroke movement limiter locking the end of the rocker arm (RF patent RU 108370, IPC B60R25/04, 2011.).

This technical solution is the closest to the technical essence and purpose of the claimed device, and therefore chosen as a prototype.

The disadvantages of prior art are the insufficient security due to rigid connection of the components of the security part and of the drive of mechanism of a locking means, enabling the selection of acoustic code and the design complexity.

### SUMMARY OF INVENTION

An increase of security and a simplification of the design are achieved by eliminating the selection code by using flexible coupling of security part with drive mechanism of a locking means.

Below are the general and specific essential features characterizing the causal relationship of technical solutions with the specified technical result.

The keyless anti-theft device comprises the security part, a locking means of gearbox lever and a drive mechanism of a locking means. Wherein the security part is formed as a set of code and false keys with rods; said rods mounted by means of sealing in gearbox and are connected by means of three-dimensional levers with weights of a drive mechanism of a locking means which is in the form of a rocker arm; said rocker arm is set to allow its vertical rotation with respect to axis. A locking end of the rocker arm having a limiter for limiting the travel of a gearbox lever adapted for interacting with a stopper, which is rigidly connected to the gearbox lever. The device is equipped with a downstroke movement limiter for locking the end of the rocker arm. Said three-dimensional levers are connected to the weights by means of flexible joining, wherein all the weights are freely arranged in open at the top baskets rigidly connected to said rocker arm and equipped with antennae preventing fallout of weights out the baskets, the baskets are arranged longitudinally on either side of the rocker arm mounting axis, thus forming at least one horizontal row. Baskets rigidly connected with the locking part of the rocking arm, wherein the tightening weights of the baskets are connected with false keys, and to the other, i.e. the ballast, part of the rocker arm rigidly connected to the baskets with the possibility of placing in them at least three counterweights connected with key codes. The ratio of total weights relating to the locking and the ballast parts of the rocker arm is performed by: allowing rotation of the rocker arm toward the ballast part when loaded with a set of counterweights; and allowing rotation of the rocker arm toward its locking part when loaded with at least one tightening weight with a simultaneous full load of baskets of the ballast part or where is no loading of the locking part or the ballast part of the rocker arm. The travel of each of said code key rods and the travel of associated counterweights is equal value B, thus allowing the latter stopping at the bottom of the baskets of the rocker arm ballast part in the locked position of the gearbox lever. The value B is inherent to all the false key tightening weights, whereby the distance between the bottom of the false key baskets, more remote from the arm rocker axis, within the rocker arm locking part and the weights being in contact is equal to B+κ₂, the value κ₂ being less than that of travel κ₁ of the rocker arm locking means till the gearbox lever coming out of the stop piece interaction, and the value B is not less than κ_{1.} Each of the rods is equipped with a rotation limiter, axial movement limiters up and down and an upper position stop, which is formed as a hinge rack, wherein the security part is equipped with the means for balancing the total weight of each of the movable elements of said security part, wherein at the top portion of gearbox located vane-type lock of the rocker arm in the open position, and said tightening weights and counterweights are made of a magnetically resistant materials, where lever and rods being passed through the support plate. Said locking means of gearbox lever in open state is made as a pivot lever with the vane on its free end paired in a working position with the rocker arm and having a handle on the other end, and the middle portion of said lever having secured means of restricting its vertical movement. Said means of restricting vertical movement of the rocker arm designed in the form of two spaced apart sleeves or one sleeve with a height equal to the distance between the upper portion of gearbox and the support plate. Said rocker arm designed L-shaped and shifted to the gearbox side wall. Hinge rack of each rod has a height that ensures its fixing in the upper position. Rotation limiter of each rod is formed as two plates attached to the gearbox, covering both sides of an insert of rectangular cross-section which is undetachably connected with the rod. The means for balancing the total weight of each of the movable elements of security section is formed as additional weights attached to the rod, the weight of which ensures the equality of the total weights of movable elements of security section, which simultaneously acts as said rod axial movement limiters. The means for balancing the total weight of each movable element of the security section is implemented by changing each three-dimensional lever material consumption. The means for balancing the total weight of each of the movable elements of security section is implemented by using different specific weight materials for each of three-dimensional lever. The means for balancing the total weight of each of the movable elements of security section is implemented by removing material in the form of through or blind openings in each tree-dimensional lever whose weight exceeds the reference. Said limiter of downward stroke of the locking end of the rocker arm is formed as a rack attached to the gearbox allowing interaction with the ballast end of the rocker arm.

### BRIEF DESCRIPTION OF THE DRAWINGS

The utility model is illustrated with drawings, wherein:

FIG. 1 is a perspective view of the device assembled with the GEARBOX lever in rear position;

FIG. 2—a top view of FIG. 1;

FIG. 3—a longitudinal section of the device;

FIG. 4—view B-B in FIG. 3;

FIG. 5—view V in FIG. 6;

FIG. 6—view I in FIG. 3;

FIG. 7—view GG in FIG. 3;

FIG. 8—view D in FIG. 3;

FIG. 9—view E in FIG. 8;

FIG. 10—view L in FIG. 11;

FIG. 11 is a general view of the device assembled with the GEARBOX lever in the forward position;

FIG. 12—view J in FIG. 11;

FIG. 13—a top view in FIG. 12;

FIG. 14—view A in FIG. 3;

FIG. 15—view Z-Z in FIG. 14;

FIG. 16 has a version of the binder in FIG. 6;

FIG. 17—view I-I in FIG. 16;

FIG. 18—sectional enlarged view of rods.

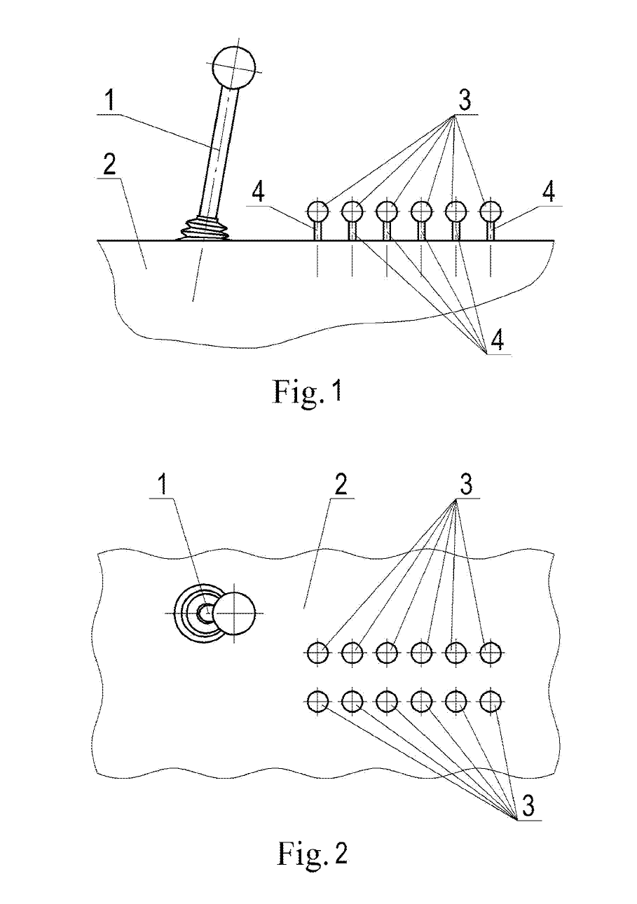

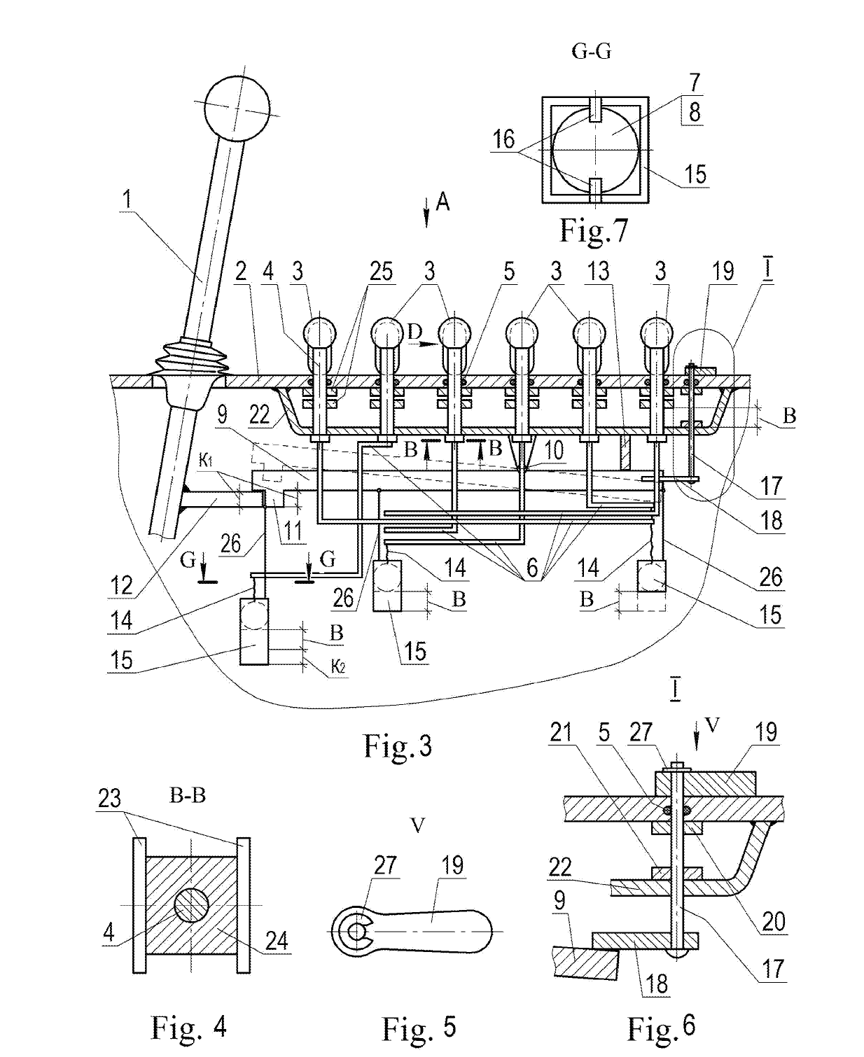

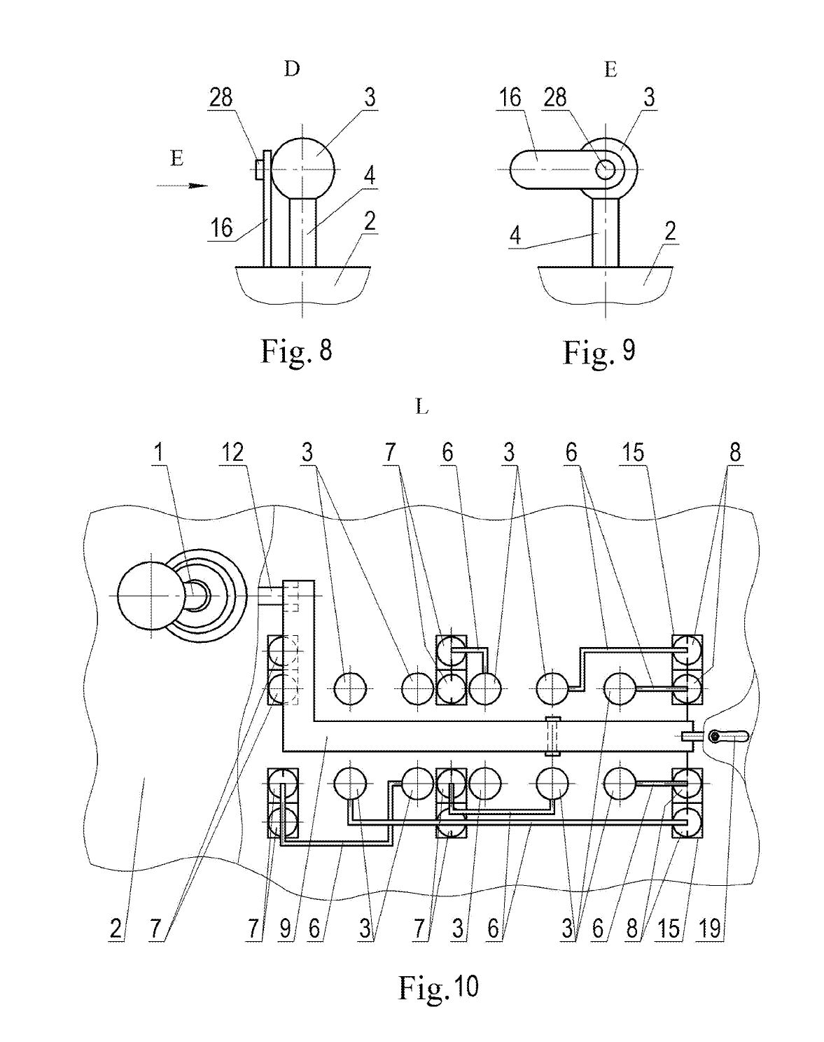

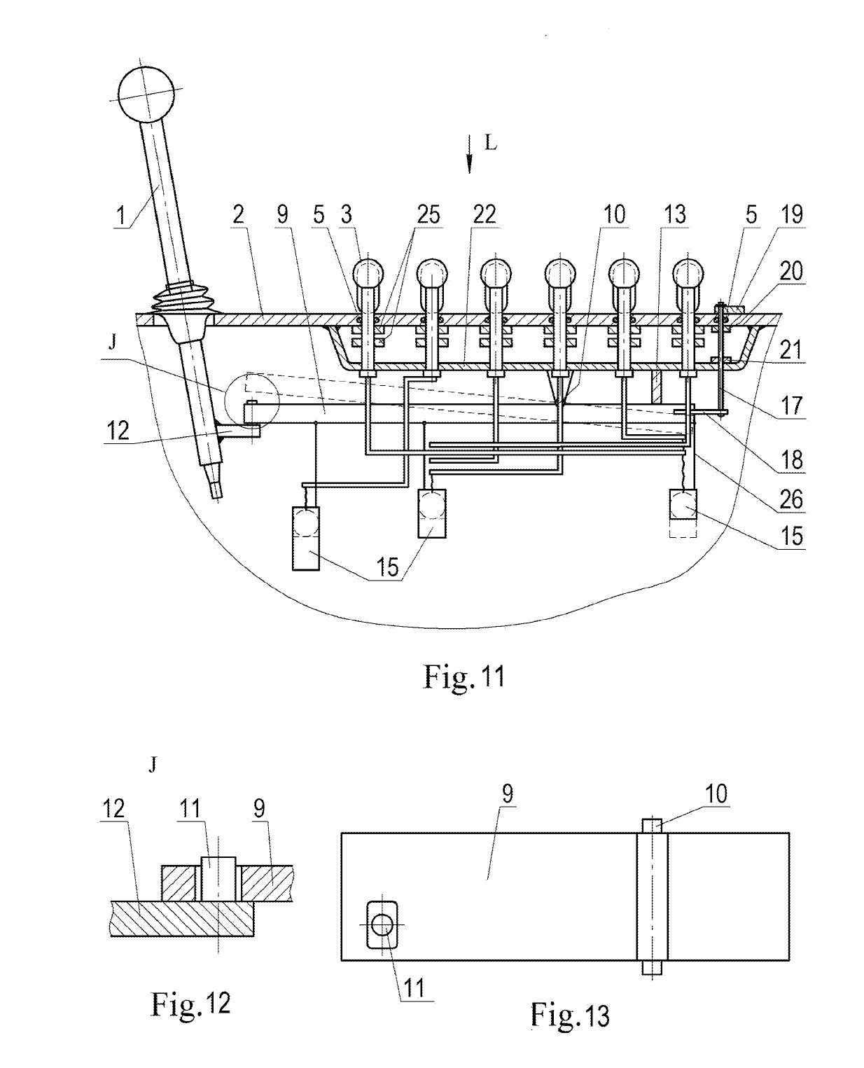

### DESCRIPTION OF THE PREFERRED EMBODIMENT

Keyless anti-theft device comprising a security part, locking means of lever 1 of gearbox 2 and drive mechanism of a locking means.

Wherein the security part is formed as a set of code and false keys 3 with rods 4, mounted by means of sealing 5 in gearbox and, which are connected by means of three-dimensional levers 6 with weights 7 and 8 of a drive mechanism of a locking means, which is in the form of a rocker arm 9, and set to allow its vertical rotation with respect to axis 10. The locking end of the rocker arm 9 having a limiter 11 for limiting the travel of a gearbox lever, adapted for interacting with stopper 12, which is rigidly connected to the lever 1 of gearbox 2.

The device is equipped with a downstroke movement limiter 13 locking the end of the rocker arm 9. Three-dimensional levers 6 are connected with the weights 7 and 8 by means of flexible connections 14. All the weights are freely placed in open at the top baskets 15, rigidly connected with said rocker arm 9 and equipped with antennae 16, preventing fallout of weights 7 and 8 out of baskets 15. The baskets 15 are arranged longitudinally on either sides of the rocker arm 9 mounting axis 10, thus forming at least one horizontal row. The baskets 15 rigidly connected with the locking part of the rocking arm 9, tightening weights 7 of which connected with false keys, and to the other, i.e. ballast, side the rocker arm 9 has rigidly connected baskets 15 with ability of placing in them at least three counterweights 8, connected with key codes. The ratio of total weights relating to the locking and the ballast parts of the rocker arm 9 performed by: allowing rotation of the rocker arm toward the ballast part when loaded with a set of counterweights 8; and allowing rotation of the rocker arm 9 toward the locking part when loaded with at least one tightening weight 7 with simultaneous full load of baskets 15 of the ballast part or when the locking part or the ballast part of the rocker arm 9 are not loaded at all. The travel of each of said code key rods 4 and the travel of associated counterweights 8 is equal value B, thus allowing the latter stopping at the bottom of the baskets 15 of the rocker arm 9 ballast part in the locked position of the lever 1 of gearbox 2. The value B is inherent to all the false key tightening weights 7, whereby the distance between the bottom of the false key baskets 15, more remote from the axis 10 of arm rocker 9, within the rocker arm locking part and the weights being in contact is equal to B+κ₂, the value κ₂ being less than that of travel κ₁ of the rocker arm locking means till the gearbox lever coming out of the stop piece interaction, and the value B is not less than κ₁

Each of the rods 3 is equipped with a rotation limiter and axial movement limiters up and down and an upper position stop, which is formed as a hinge rack 16, where security part is equipped with means for balancing the total weight of the movable elements. At the top portion of gearbox located vane-type lock of the rocker arm 9 in the open position, said tightening weights 7 and counterweights 8 are made of a magnetically resistant materials.

Locking means is formed as of a downward projection 11 adapted to contact with the stop 12 on the gearbox lever in the operation position of the device and allowing locking of the lever 1 of gearbox 2 in its forward position or may be designed as a transverse slot allowing free engagement with a projection, located at the end of gearbox lever in its rear position.

Locking means of gearbox lever in open state is made as a pivot lever 17 with the vane 18 on the free end paired in a working position with the rocker arm 9 and having a handle 19 on the other end, and the middle portion of said lever 17 secured by the means 20 and 21 restricting its vertical movement. The lever 17 and the rod 4 are passed through a support plate 22. Hinge rack 16 of each rod 4 has a height ensuring its fixing in the upper position. Rotation limiter of each rod 4 is formed as two plates 23 attached to the gearbox, enfolding from either side the insertion of rectangular cross-section 24 undetachably connected with the rod 4. The means for balancing the total weight of each of the movable elements of security section can be formed as additional weights 25 attached to the rod 4, whose weight ensures the equality of the total weights of movable elements of security section, which simultaneously acts as said rod 4 axial movement limiters. The rigid connection between baskets 15 and a rocking arm 9 can be made, for example in the form of rods 26, where flexible connections 14 are located alongside.

The means for balancing the total weight of each of the movable elements of security section can be implemented by change of each three-dimensional lever material consumption or by using different specific weight materials for each of three-dimensional lever 6, or by removing material in the form of through or blind openings in each tree-dimensional lever 6 whose weight exceeds the reference.

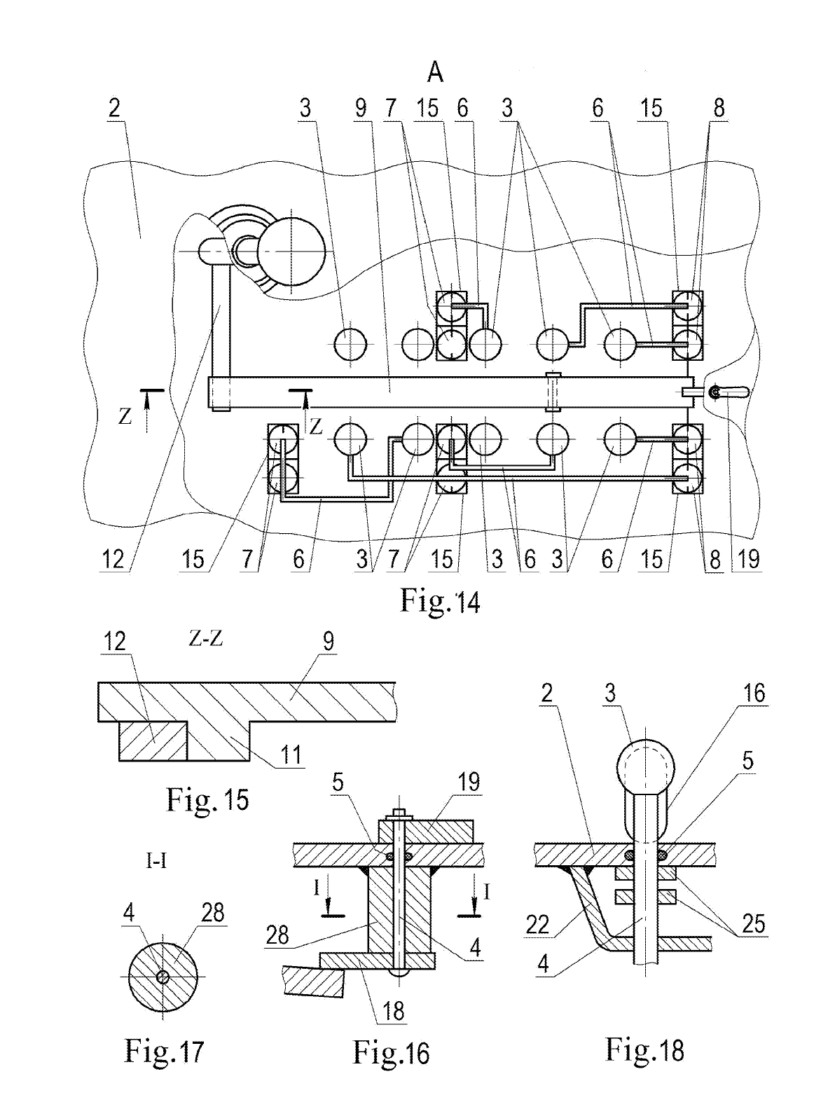

The limiter of downward stroke of the locking end of the rocker arm can be in the form of attached to the gearbox rack 13 allowing interaction with the ballast end of the rocker arm 9. The pivot lever 17 of vane 18 has a handle 19 secured, for example by a slotted stop washer 27, a rack 16 is set on the axis 28. The rocker arm 9 can be placed against the wall of gearbox, and then it is executed L-shaped (FIG. 10, FIG. 14) with a corresponding change in the shape and attachment stop point 12 of the gearbox lever.

Comparison of the technical solution to the prior art known to the scientific, technical and patent documentation on the priority date in the main and related headings found no remedy, which has features identical to all the grounds contained in the formula suggested by the applicant solution, including the description of the destination. That is, the set of essential features of the claimed solution not previously been known and is not identical to any known technical solutions therefore, it corresponds to the patentability of “novelty”.

This technical solution is industrially applicable, as in the description of the application and in the name of the this invention its function indicated, it may be manufactured by industrial process and used as a car anti-theft device, it is efficient, feasible and reproducible, and features allow the device to get a specific technical result.

This invention in the form as it is characterized in each of the claims may be implemented using the tools and methods described in the prior art, which became public before the priority date of this device. Consequently, the technical solution meets the patentability of “industrial applicability”.

The Device Operates as Follows.

To lock the gearshift, its arm 1 transferred to the forward or rearward position on the direct, forward or reverse gear, and then removing locking by vane 18 of the rocker arm 9; it descends downwardly and engages with stopper 12 of locking lever 1. In this position, the rods 4 are pulled in the upper position and fixed by racks 16.

To unlock the gearbox code keys are pressed down and the counterweight 8 with baskets 15 are released and lowered by the value B. Due to this, the ballast part descends, and rocker arm 9 disengages from the stopper 12 enabling car to drive. Thus, the rocker arm is locked with the vane 18 and then all rods of keys 3 move downwards.

In case of typing the wrong code tightening weights 7 of false keys equally spaced from the code keys also descend on the value B and the attacker cannot distinguish them from the code keys by the value of their travel.

In case when all code keys are pressed down, the locking part of the rocker arm 9 will not ascend because flexible connections of levers 6 with weights are relaxed and the torque caused by the weight of the locking portion relative to the axis of the rocker arm greater than torque based on the total weight of its ballast part and counterweights.

If the wrong code entered, tightening weights 7 of the false keys are remoted at a greater distance from the axis 10 of the rocker arm 9, than code keys also descend by the value B and the attacker cannot distinguish them from the code keys by the value of their travel. In this case, the torque relative to the axis 10 of the rocker arm 9 caused by impact of weight of locking part of the rocker arm even when only one false key is pressed will exceed reverse torque caused by the impact of the cumulative weight of the ballast part and counterweights 8, thus the rocker arm cannot be disengaged from stopper 12 of lever 1 of gearbox, because value κ₂ is lower than height κ₁ of stopper 11 on rocker arm and equal to thickness of the stopper 12 at the lever 1.

Using the device makes it possible to increase the security of the device and expand the operational capability by reducing weight.

1. Keyless anti-theft device comprising a security part, locking means of gearbox lever and drive mechanism of a locking means, wherein the security part is formed as a set of code and false keys with rods mounted by means of sealing into a gearbox and connected by means of three-dimensional levers to weights of a drive mechanism of a locking means, having the form of a rocker arm; said rocker arm is set to allow its vertical rotation with respect to axis, wherein locking end of the rocker arm having a limiter for limiting the travel of a gearbox lever, adapted for interaction with stopper, which is rigidly connected to the gearbox lever, wherein the device is equipped with a downstroke movement limiter for limiting the rocker arm locking end descending travel, wherein three-dimensional levers are connected to the weights by means of flexible connections, wherein all the weights are freely placed in open at the top baskets rigidly connected with said rocker arm and equipped with antennae preventing fallout of weights out of the baskets, the baskets are arranged longitudinally on either side of the rocker arm mounting axis, thus forming at least one horizontal row, wherein the baskets rigidly connected with the locking part of the rocking arm, tightening weights of which connected with false keys, and to the other ballast side of the rocker arm rigidly connected baskets with the possibility of placing in them at least three counterweights, connected to the code keys, wherein the ratio of total weights relating to the locking and the ballast parts of the rocker arm is performed in order to allow rotation of the rocker arm towards the ballast part when loaded with a set of counterweights; and allowing rotation of the rocker arm toward the locking part when loaded with at least one tightening weight with simultaneous full load of baskets of the ballast part or when the rocker arm locking and ballast parts are not loaded at all; wherein the travel of each of said code key rods and the travel of associated counterweights is equal to the value B, thus allowing the latter stopping at the bottom of the baskets of the rocker arm ballast part in the locked position of the gearbox lever, wherein the value B is inherent to all the false key tightening weights, whereby the distance between the bottom of the false key baskets, more remote from the arm rocker axis, within the rocker arm locking part and the weights being in contact is equal to B+κ_{2,} the value κ₂ being less than that of travel κ₁ of the rocker arm locking means till the gearbox lever coming out of the stop piece interaction, and the value B is not less than κ₁, wherein each of the rods is equipped with a rotation limiter, axial movement limiters up and down and an upper position stop formed as a hinge rack, wherein the security part is equipped a means for balancing the total weight of all the movable elements of said security part, wherein at the top portion of gearbox located vane-type lock of the rocker arm in the open position, wherein said tightening weights and counterweights are made of magnetically resistant materials, the lever and rods being passed through a support plate.

2. The keyless anti-theft device according to claim 1, wherein said locking means formed as a downward projection allowing its contact with the gearbox lever stop in the operating position of the device and allowing fixing the gearbox lever in its front position.

3. The keyless anti-theft device according to claim 1, wherein said locking means is designed as a transverse slot allowing free engagement with a projection, located at the end of gearbox lever in its rear position.

4. The keyless anti-theft device according to claim 1, wherein said locking means of gearbox lever in open position is made as a pivot lever with the vane on its free end paired in a working position with the rocker arm and having a handle on the other end, and in its middle portion said lever has a limiter for limiting its vertical travel.

5. The keyless anti-theft device according to claim 1, wherein said locking means of restricting vertical travel of the lever is designed in the form of two spaced apart sleeves or one sleeve with a height equal to the distance between the upper portion of gearbox and the support plate.

6. The keyless anti-theft device according to claim 1, wherein said rocker arm is designed L-shaped and shifted to the gearbox side wall.

7. The keyless anti-theft device according to claim 1, wherein each rod hinge rack has a height that ensures its fixing in the upper position.

8. The keyless anti-theft device according to claim 1, wherein each rod rotation limiter is formed as two plates attached to the gearbox, covering from either side a rectangular cross-section insert of which is undetachably connected with the rod.

9. The keyless anti-theft device according to claim 1, wherein the means for balancing the total weight of each of the movable elements of security part is formed as additional weights attached to the rod, the weight of which ensures the equality of the total weights of movable elements of security section, and simultaneously the additional weights act as said rod axial movement limiters.

10. The keyless anti-theft device according to claim 1, wherein the means for balancing the total weight of each of the movable elements of security part is implemented by changing material consumption for each three-dimensional lever.

11. The keyless anti-theft device according to claim 1, wherein the means for balancing the total weight of each of the movable elements of security part is implemented by using different specific weight materials for each of three-dimensional lever.

12. The keyless anti-theft device according to claim 1, wherein the means for balancing the total weight of each of the movable elements of security part is implemented by removing material in the form of through or blind openings in each tree-dimensional lever whose weight exceeds the reference.

13. The keyless anti-theft device according to claim 1, wherein said limiter of downward travel of the locking end of the rocker arm is in the form of a rack attached to the gearbox allowing for interacting with the ballast end of the rocker arm.
